(19) United States
(12) Patent Application Publication
(10) Pub. No.: US 2026/0063924 A1
(43) Pub. Date: Mar. 5, 2026

(54) PARABOLOID LENS AND EYEWEAR COMPRISING SUCH A LENS

(71) Applicant: LUXOTTICA S.R.L., Agordo (BL) (IT)

(72) Inventors: Vincenzo SPREMULLI, San Mauro Torinese (TO) (IT); Pietro FRIGENI, Chivasso (TO) (IT)

(73) Assignee: LUXOTTICA S.R.L., Agordo (BL) (IT)

(21) Appl. No.: 19/108,189

(22) PCT Filed: Sep. 14, 2023
(86) PCT No.: PCT/IB2023/059127

§ 371 Date: Mar. 3, 2025

(30) Foreign Application Priority Data
Sep. 15, 2022 (IT) 102022000018903
May 5, 2023 (IT) 102023000009000

(51) Int. Cl. G02C 7/02; G02B 3/00; G02B 3/04; G02B 3/06; G02C 7/10

(52) U.S. Cl. CPC G02C 7/02; G02B 3/04; G02B 3/06; G02C 7/10; G02B 2003/0093

(57) ABSTRACT

A lens for spectacles and/or masks having an inner surface apt to be directed toward at least an eye of a wearer and an outer surface opposite to the inner surface is described, a first inner central curve and a second inner central curve are defined on the inner surface, a first outer central curve and a second outer central curve are defined on the outer surface; the first inner central curve and the first outer central curve are defined by the intersection of the inner surface and the outer surface, respectively, with a first plane passing through the geometric center of the lens and extending in a substantially vertical direction; the second inner central curve and the second outer central curve are defined by the intersection of the inner surface and the outer surface, respectively, with a second plane passing through the geometric center of the lens.

The present invention relates to a paraboloid lens, an eyewear comprising such a lens and a process for designing and/or making such a lens. The present invention applies to the field of spectacles, in particular to protective spectacles and/or masks, but also to ophthalmic spectacles and/or masks.

The present invention is usefully employed for making sun spectacles and/or masks.

The present invention is usefully employed also for making corrective or ophthalmic spectacles and/or masks.

Spectacles and/or masks with lenses having an inner surface apt to be directed toward the wearer's eye and an opposite surface which is directed toward the outside are known. In known spectacles and/or masks, the outer surface of the lenses is a convex surface while the inner surface is a concave surface.

Such specific conformation of the surfaces of the lenses restricts the shape the same can assume, and accordingly sets limits to the freedom to confer particular and unexpected aesthetic effects to the lenses themselves. Currently, indeed, aesthetic effects can be conferred only in relation to the shape of the lenses, i.e., to the shape of the cut, and to the possible tinting thereof.

Disadvantageously, furthermore, the lenses thus made are poorly adapted to some face shapes.

The basic task of the present invention consists in providing a lens, an eyewear comprising such a lens and a process for designing and/or making such a lens, which overcomes the above-mentioned drawbacks of the known art.

A particular object of the present invention is to provide a lens to which a desired aesthetic shape different from that distinguishing the known-type lenses can be conferred.

A further object of the present invention is to provide a lens which is particularly suitably conformed to some face types.

A further object of the present invention is also to provide a lens in which the optical aberrations are minimized, or which has a desired optical power, and in which the resolution features of the lens itself are better.

Another object of the present invention is to provide a lens that meets the requirements imposed by the current regulations in the field of spectacles.

The task set forth above, as well as the mentioned objects and other objects that will be more apparent below, are achieved by a lens as stated in claim 1, wherein said lens has an inner surface apt to be directed toward an eye of a wearer and an outer surface opposite to the inner surface; said inner surface and outer surface being spaced from each other defining a thickness;
on said inner surface of said lens being defined a first inner central curve and a second inner central curve; on said outer surface of said lens being defined a first outer central curve and a second outer central curve;
said first inner central curve and said first outer central curve being defined by the intersection of said inner surface and said outer surface, respectively, with a first plane passing through the geometric center of the lens and extending in a substantially vertical direction;
said second inner central curve and said second outer central curve being defined by the intersection of the inner surface and outer surface respectively with a second plane passing through the geometric center of the lens; said second plane being tilted with respect to a horizontal direction by an angle between −25°and 25°;
characterized in that
said inner surface is convex at least along said first inner central curve and concave at least along said second inner central curve toward the wearer's eye;
said outer surface is convex at least along said first outer central curve and concave at least along said second outer central curve toward the wearer's eye.

Preferably, the second plane extends in a substantially horizontal direction.

The invention also concerns an eyewear as recited in claims 14 and 15.

Other features are provided in the dependent claims.

Further features and advantages will be more apparent from the description of preferred, but not exclusive, embodiments of a lens, an eyewear, and a process for designing and/or making such a lens, illustrated in an indicative and non-limiting way with the aid of the attached drawings in which:

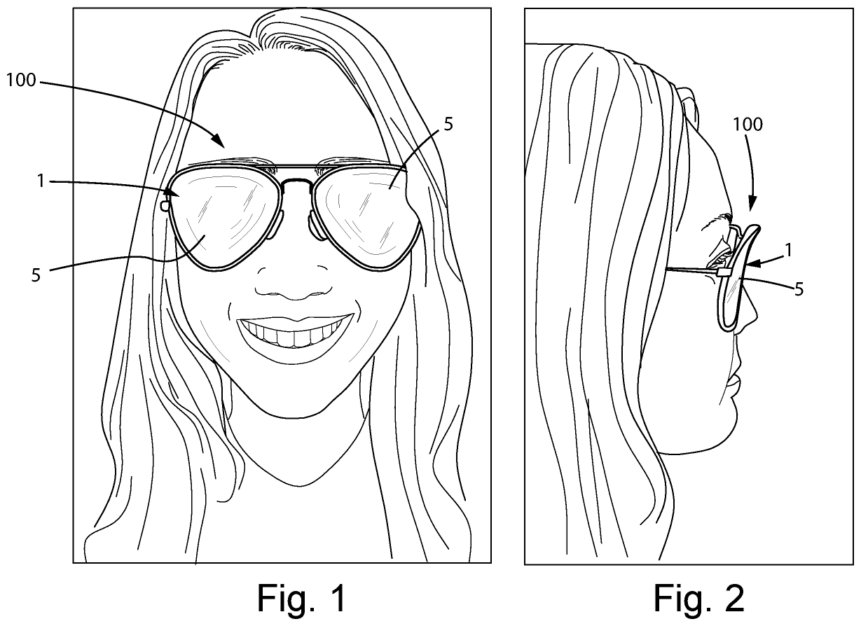

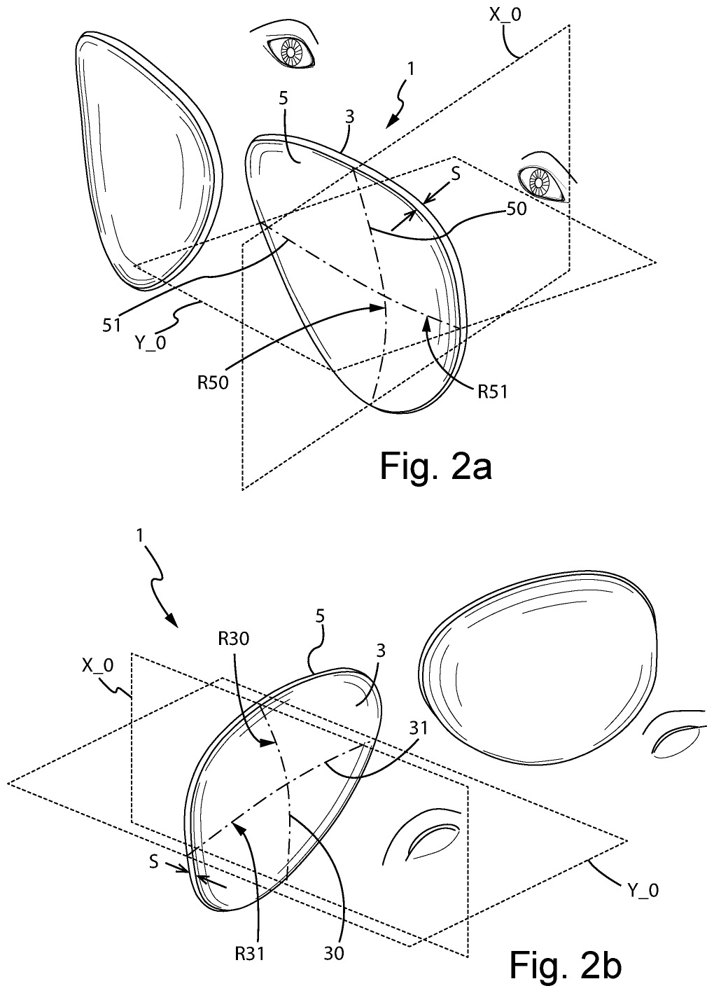

FIGS. 1 and 2 show a pair of spectacles comprising a pair of lenses according to the present invention;

FIGS. 2a and 2b show two different views of a pair of lenses according to the present invention;

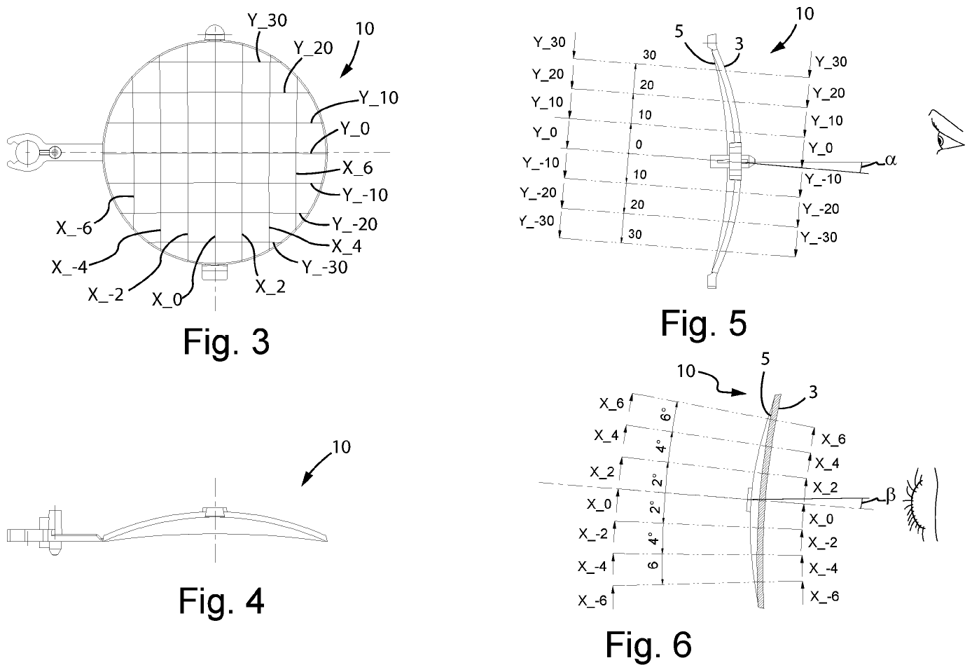

FIG. 3 shows a plan view of a semifinished lens, before it is shaped to form a lens according to the present invention, with sectional planes X-X passing through the axis of revolution of the toroid generating the outer surface of the semifinished lens and with sectional planes Y-Y orthogonal to the axis of the toroid;

FIG. 4 shows the semifinished product of FIG. 3 in a top view;

FIG. 5 shows the semifinished product of FIGS. 3 and 4 in a side view with some sectional planes Y-Y perpendicular to the sectional planes X-X;

FIG. 6 shows the semifinished product of FIGS. 3-5 in a different side view with some sectional planes X-X passing through the axis of revolution of the toroid generating the outer surface of the semifinished lens;

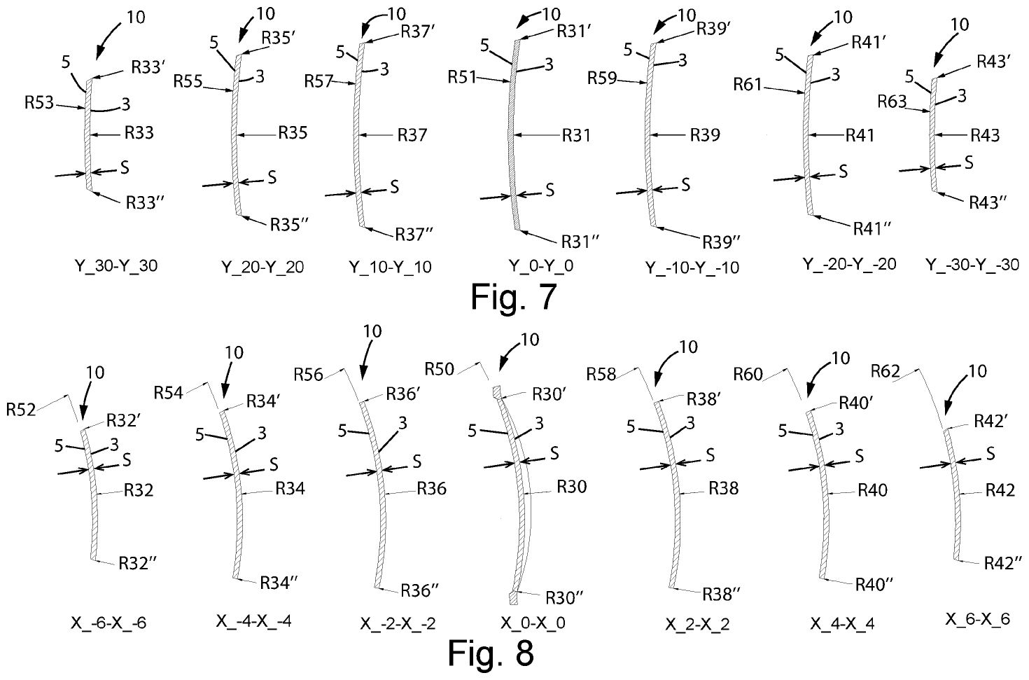

FIG. 7 shows the semifinished product of FIG. 5 sectioned along the planes Y-Y depicted in FIG. 5;

FIG. 8 shows the semifinished product of FIG. 6 sectioned along the planes X-X depicted in FIG. 6;

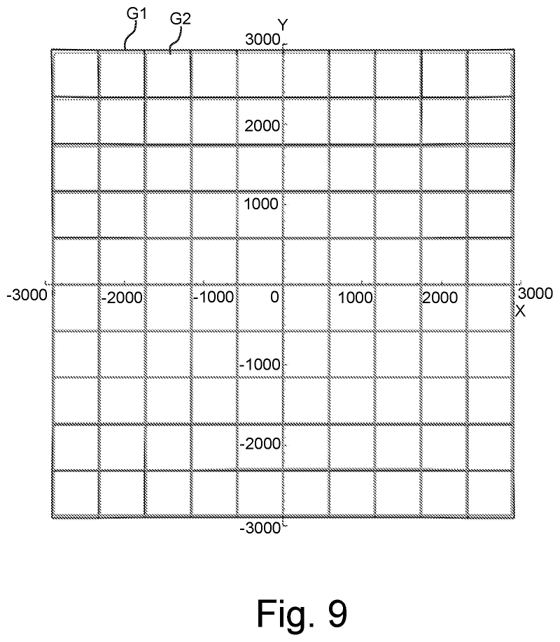

FIG. 9 schematically illustrates the comparison between a reference grid representing an ideal case of lens, i.e., devoid of aberrations, and a grid associated to a lens according to the present invention;

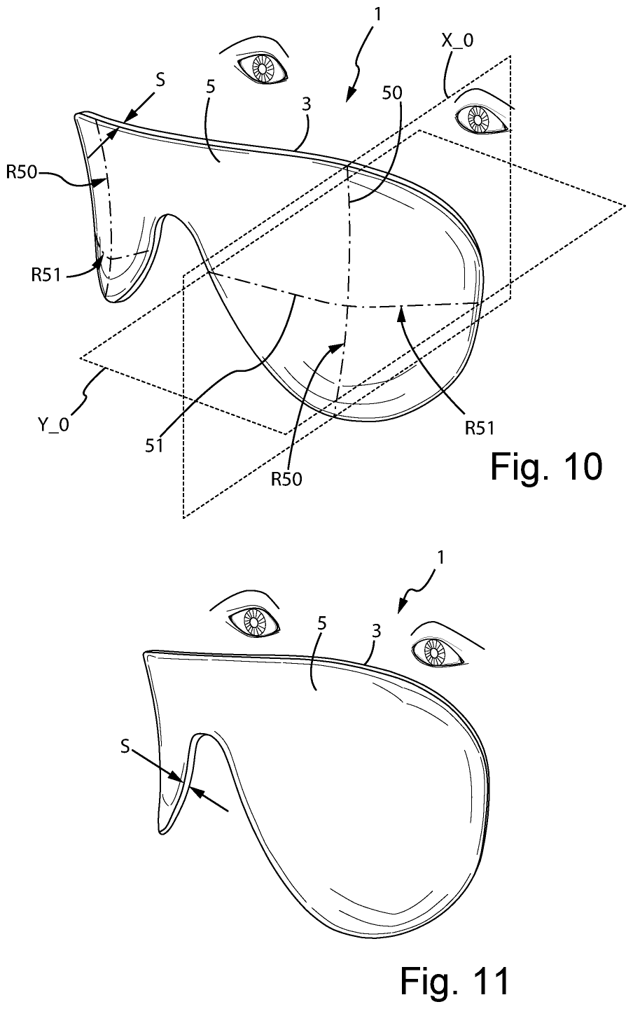

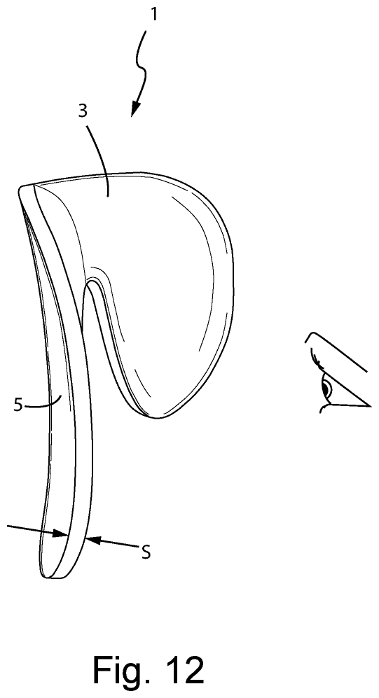

FIGS. 10-12 show different perspective views of a lens for a mask according to the present invention.

With reference to the attached figures, a lens 1 for spectacles and/or masks is described below.

In FIGS. 3-8 a semifinished lens 10, i.e., a round from which, through a cutting process referred to as “shaping”, the lens 1 is then formed, is particularly shown. What is shown with reference to the semifinished product 10, however, applies to the lens 1, as the properties of the lens 1, such as the optical and geometrical features, are already present in the semifinished product 10 which is then shaped to make the lens 1.

The lens 1 according to the present invention has an inner surface 3, apt to be directed toward at least an eye of a wearer.

In particular, the term wearer means, in the present disclosure, a person wearing a pair of spectacles comprising two distinct lenses or a mask with a single lens according to the present invention.

An eyewear comprising at least one lens 1 as described in the present disclosure forms also part of the present invention. The term eyewear means, in the present disclosure, any kind of spectacles or mask.

Indeed, spectacles 100 comprising at least one lens 1 as described in the present disclosure, preferably comprising two lenses 1, form also part of the present invention.

A mask comprising a single lens 1 as described in the present disclosure forms also part of the present invention.

According to a first preferred embodiment, the eyewear is sun spectacles and/or sun mask, and thus the lens 1 is preferably a sun lens.

According to a second preferred embodiment, the eyewear is corrective spectacles and/or corrective mask, and thus the lens 1 is preferably a corrective or ophthalmic lens.

Said lens 1 is suitable for all the types of frames of spectacles 100 and/or masks, whether they are made of cellulose acetate, injected, metal and/or “rimless”.

The lens 1 is thus preferably a lens of thermoplastic material or acrylic polymers, such as for example polyamide and/or bio-polyamide. Alternatively, the lens 1 is made of polycarbonate.

The lens 1 further has an outer surface 5, opposite to the inner surface 3.

Preferably, the outer surface 5 is cylindrical.

The inner surface 3 and outer surface 5 are spaced from each other defining a lens thickness S. Said lens thickness S is indicatively between 0, 8 mm and 5 mm. Preferably, the lens thickness S is 2 mm.

In a preferred embodiment, the lens 1 is a shaded lens. The shades can be added to the lenses for spectacles and/or masks, on one hand in order to improve the aesthetics thereof and on the other hand in order to attenuate for example the light intensity that is conveyed to the wearer's eyes. Alternatively, the lens 1 is a tinted lens. The shading or tinting can be of any typology or “pattern,” by way of example but not limited to, classic gradient shading, circular shading, overlapping shading, clear shading, or shape shading.

The lens 1 can be of both the polar type and the non-polar type. In the polar embodiment, the lens 1 is functionalized, for example comprises a polarizing layer and/or a photochromatic layer and/or a layer with contrast enhancement properties.

A number of treatments, by way of example but not limited to, anti-reflection, mirroring, anti-fog, hydrophobic and/or anti-stain, anti-scratch, anti-static treatments, and other treatments known in the state of the art, can be applied to the lens 1. Said treatments can be applied on the outer surface 5 and/or on the inner surface 3 of the lens 1.

The lens 1 can comprise two-dimensional and/or three-dimensional patterns. Also, finishing treatments can be applied to the lens 1. For instance, surface patterns obtained by lasering or pad printing, or other techniques known in the state of the art, can be applied to the lens 1.

Furthermore, decorations by UV/laser printing and/or pad printing and/or engraving can be applied to the lens 1 and/or two-dimensional elements can be inserted into the lens 1, visible or not visible by anyone observing the lens 1 from the outside, such as two-dimensional inserts containing electronics (e.g. RFID tag) for decorative and/or functional purposes.

The lens 1 can be made by injection molding, casting, or thermoforming processes.

A first inner central curve 30 and a second inner central curve 31 are defined on the inner surface 3 of the lens 1.

Furthermore, a first outer central curve 50 and a second outer central curve 51 are defined on the outer surface 5 of the lens 1.

In particular, the first inner central curve 30 and the first outer central curve 50 are defined by the intersection of the inner surface 3 and the outer surface 5, respectively, with a first plane X_0. Such first plane X_0 passes through the geometric center of the lens 1 and extends in a substantially vertical direction. In the present disclosure, the terms vertical and horizontal are to be intended with reference to the lens/es mounted in the frame of spectacles or mask and with respect to the wearer. Such first plane X_0 further passes through the axis of revolution of the toroid generating the outer surface 5 in the case of a toric lens 1. In the case of an other-shaped lens 1, the first plane X_0 is a substantially vertical plane still passing through the geometric center of the lens 1.

On the other hand, the second inner central curve 31 and the second outer central curve 51 are defined by the intersection of the inner surface 3 and the outer surface 5, respectively, with a second plane Y_0. Such second plane Y_0 passes through the geometric center of the lens 1. Such second plane Y_0 is tilted with respect to a horizontal plane by an angle between −25°and +25°.

It should be noted that the second plane Y_0 can be tilted with respect to a horizontal plane also by an angle equal to 0, i.e. it can be substantially parallel to a horizontal plane.

Preferably, the second plane extends in a substantially horizontal direction. In the case of a toric lens, the second plane Y_0 is parallel to a plane defined as the plane orthogonal to the axis of revolution of the toroid and passing through the center of the circumference generating the toroid.

According to an embodiment, in the case of a toric lens 1, such second plane Y_0 is preferably tilted with respect to a horizontal plane by a first angle a, said pantoscopic angle, between −25°and +25°. In other words, once defined as the horizontal plane a plane horizontally sectioning the toroid in two parts, the second plane Y_0 is a plane tilted with respect to said horizontal plane by such first angle α.

According to the shown example, a is between −4° and −5°, and in particular is equal to −4.625°.

According to a first preferred embodiment, for any type of lens 1, the first plane X_0 is preferably tilted with respect to a vertical plane by a second angle β, said winding angle, between −30°and +30°. In other words, once defined as the vertical plane a plane vertically sectioning the lens 1 in two parts, the first plane X_0 is a plane tilted with respect to said vertical plane by such second angle β.

Preferably, β is between 5°and 7°.

According to the present invention, with reference to FIGS. 2a and 2b, it should be noted that the inner surface 3 is, with respect to the wearer's eye, convex at least along the first inner central curve 30. The inner surface 3 is further, with respect to the wearer's eye, concave at least along the second inner central curve 31.

Still with reference to FIGS. 2a and 2b, on the other hand, the outer surface 5, with respect to the wearer's eye, is convex at least along the first outer central curve 50 and is concave at least along the second outer central curve 51.

In other words, the lens 1 is, for those looking at it from the outside, concave in a substantially vertical direction and convex in a direction that is tilted by an angle between −25°and 25°with respect to a horizontal direction.

Such “vertical” outer concavity effect is aesthetically appreciable for those looking at the lens 1 worn by the wearer, as exemplified in particular in FIGS. 2 and 2a.

Advantageously, the lens 1 has therefore a paraboloid shape.

According to the present invention, preferably the inner surface 3 has, at least along the first inner central curve 30, a radius of curvature R30 that varies continuously and in an increasing and/or decreasing manner.

In particular, the radius of curvature R30 varies continuously, meaning that the inner surface 3 has no discontinuity (e.g., steps) along the first inner central curve 30.

Furthermore, the radius of curvature R30 varies in an increasing, or decreasing, manner, or both increasing and decreasing manner, in different parts of the inner surface 3 along the first inner central curve 30. In other words, the radius of curvature R30 is not a constant radius throughout the first inner central curve 30.

Similarly, even preferably, the inner surface 3 further has, at least along the second inner central curve 31, a radius of curvature R31 that varies continuously and in an increasing and/or decreasing manner.

In particular, the radius of curvature R31 varies continuously, meaning that the inner surface 3 has no discontinuity (e.g., steps) along the second inner central curve 31.

Furthermore, the radius of curvature R31 varies in an increasing, or decreasing, manner, or both increasing and decreasing manner, in different parts of the inner surface 3 along the second inner central curve 31. In other words, the radius of curvature R30 is not a constant radius throughout the second inner central curve 31.

Preferably, the radius of curvature R30 of the inner surface 3 along the first inner central curve 30 is at least partly increasing and at least partly decreasing.

Still preferably, the radius of curvature R31 of the inner surface 3 along the second inner central curve 31 is at least partly increasing and at least partly decreasing.

Preferably, the radius of curvature R30 of the inner surface 3 along the first inner central curve 30 is different from the radius of curvature R31 of the inner surface 3 along the second inner central curve 31.

In other words, preferably, the radius of curvature varies within the inner surface 3.

Still preferably, the outer surface 5 has, at least along the first outer central curve 50, a constant radius of curvature R50.

Preferably, the outer surface 5 has, at least along the second outer central curve 51, a constant radius of curvature R51.

Preferably, the radius of curvature R50 along the first outer central curve 50 and the radius of curvature R51 along the second outer central curve 51 are different from each other.

For example, in the specific embodiment illustrated in the attached figures, the radius of curvature R50 along the first outer central curve is about 130, 5 mm while the radius of curvature R51 along the second outer central curve 51 is about 261 mm.

Still preferably, the thickness S of the lens 1 varies continuously.

In particular, the thickness S varies with the radius of curvature R30, R31 of the inner surface 3 being the radius of curvature R30, R31 of the inner surface 3 that varies along the first inner central curve 30 or along the second inner central curve 31, while the radius of curvature R50, R51 of the outer surface 5 is constant along the corresponding first outer curve R50 and second outer curve R51.

According to a preferred embodiment, the inner surface 3 has, along further first inner curves defined by the intersection of the inner surface 3 with further planes X_-6, X_-4, X_-2, X_2, X_4, X_6 angularly spaced with respect to the first plane X_0, further radii of curvature R32, R34, R36, R38, R40, R42, visible in FIG. 8. In particular, each radius of curvature R32, R34, R36, R38, R40, R42 varies continuously and in an increasing and/or decreasing manner along the respective further first inner curve.

The planes X_0, X_2, X_4, X_6, X_-2, X_-4, X_-6 are shown in FIG. 6 and are arbitrary. For example, the depicted planes X_0, X_2, X_4, X_6, X_-2, X_-4, X_-6 are angularly spaced from each other by 2°.

Still preferably, the inner surface 3 has a radius of curvature that varies continuously and in an increasing and/or decreasing manner along each first inner curve defined by the intersection of the inner surface 3 with any radial plane angularly spaced with respect to the first plane X_0.

In other words, on the inner surface 3, each further first inner curve defined on the inner surface 3 by any plane X-X, angularly spaced from X_0, has a radius of curvature that is not constant and that varies continuously.

Basically, preferably not only the further planes X_2, X_4, X_6, X_-2, X_-4, X_-6, but all the planes angularly spaced with respect to the first plane X_0, have a radius of curvature that varies continuously and in an increasing and/or decreasing manner.

Preferably, on the inner surface 3, each of such curves has a radius of curvature that is at least partly increasing and at least partly decreasing, i.e., the radius of curvature is increasing for at least a segment of the curve and is decreasing for at least a segment of the curve.

For example, the radius of curvature R30 is smaller in the central part of the lens 1 and greater at the edges of the lens 1. In other words, the radius of curvature decreases from a determined value R30 at the center of the curve, going toward the outside of the lens 1, to determined values at the edges of the curve R30′, R30″.

Thus, along the first inner central curve 30, the thickness S of the lens 1 is greater in the central part and smaller in the peripheral part.

Thus, according to an embodiment, the radius of curvature varies along the first inner central curve 30 such that R30′ and R30″ are smaller than R30.

For example, in the specific embodiment illustrated in the attached figures, the radius of curvature R30 along the first inner central curve 30 at the center of the curve is approximately equal to 130 mm.

Still preferably, such trend is valid for all the first inner curves.

In particular, in the specific embodiment illustrated in the attached figures, along the further first inner curves, the radii of curvature R32′ and R32″, R34′ and R34″, R36′ and R36″, R38′ and R38″ at the edges are smaller than the respective radii of curvature R32, R34, R36, R38, R40, R42 at the center of the respective curves.

Still according to a preferred embodiment, the inner surface 3 has, along further second inner curves defined by the intersection of the inner surface 3 with planes Y_10, Y_20, Y_30, Y_-10, Y_-20, Y_-30 parallel to the second plane Y_0, further radii of curvature R37, R35, R33, R39, R41, R43, visible in FIG. 7. In particular, each radius of curvature R37, R35, R33, R39, R41, R43 varies continuously and in an increasing and/or decreasing manner along the respective further second inner curve.

The parallel planes Y_10, Y_20, Y_30, Y_-10, Y_-20, Y_-30 are shown in FIG. 5 and are arbitrary. For example, the depicted parallel planes Y_10, Y_20, Y_30, Y_-10, Y_-20, Y_-30 are 10 mm spaced from each other.

Still preferably, the inner surface 3 has a radius of curvature that varies continuously and in an increasing and/or decreasing manner along each second inner curve defined by the intersection of the inner surface 3 with any plane parallel to the second plane Y_0.

In other words, on the inner surface 3, each further first inner curve defined on the inner surface 3 by any plane parallel to Y_0, has a radius of curvature that is not constant and that varies continuously.

Basically, preferably not only the further parallel planes Y_10, Y_20, Y_30, Y_-10, Y_-20, Y_-30, but all the planes parallel with respect to the second plane Y_0, have a radius of curvature that varies continuously and in an increasing and/or decreasing manner.

Preferably, on the inner surface 3, each of such curves has a radius of curvature that is at least partly increasing and at least partly decreasing, i.e., the radius of curvature is increasing for at least a segment of the curve and is decreasing for at least a segment of the curve.

For example, the radius of curvature R31 is greater in the central part of the lens 1 and smaller at the edges of the lens 1. In other words, the radius of curvature increases from a determined value R31 at the center of the curve, toward the outside of the lens 1, to determined values at the edges of the curve R31′, R31″.

Thus, along the second inner central curve 31, the thickness S of the lens 1 is greater in the peripheral part and smaller in the central part.

Thus, according to an embodiment, the radius of curvature varies along the second inner central curve 31 such that R31′ and R31″ are greater than R31.

Still preferably, such trend is valid for all the second inner curves.

In particular, along the further second inner curves, the radii of curvature R33′ and R33″, R35′ and R35″, R37′ and R37″, R39′ and R39″ at the edges are greater than the respective radii of curvature R33, R35, R37, R39, R41, R43 at the center of the respective curves.

Still according to a preferred embodiment, the outer surface 5 has, along further first outer curves defined by the intersection of the outer surface 5 with planes X_0, X_2, X_4, X_6, X_-2, X_-4, X_-6, angularly spaced from the first plane X_0, further radii of curvature R50, R58, R60, R62, R56, R54, R52, visible in FIG. 8. In particular, each radius of curvature R50, R58, R60, R62, R56, R54, R52 is constant along the respective further first outer curve.

Still preferably, the radius of curvature of the outer surface 5 is constant along all the further first outer curves and furthermore all the radii of curvature R33, R35, R37, R39, R41, R43 along each further first outer curve are equal to each other.

In other words, preferably R52, R54, R56, R58, R60, R62 are equal to each other, and are equal to the radius of curvature R50 along the first outer curve 50.

Still preferably, the outer surface 5 has a constant radius of curvature along each first outer curve defined by the intersection of the outer surface 5 with any plane angularly spaced with respect to the first plane X_0. All the radii of curvature along all the first outer curves are preferably equal to each other.

Still according to a preferred embodiment, the outer surface 5 has, along further second outer curves defined by the intersection of the outer surface 5 with planes Y_10, Y_20, Y_30, Y_-10, Y_-20, Y_-30 parallel to the second plane Y_0, further radii of curvature R57, R55, R53, R59, R61, R63, visible in FIG. 7. In particular, each radius of curvature R53, R55, R57, R59, R61, R63 is constant along the respective further second outer curve.

Still preferably, the radius of curvature of the outer surface 5 is constant along all the further second outer curves. Furthermore, all the radii of curvature R53, R55, R57, R59, R61, R63 along each further second outer curve are different from each other.

In other words, preferably the radii of curvature R53, R55, R57, R59, R61, R63 are constant along the respective further second curve but vary between one second curve and the other. Still preferably, the radii of curvature R53, R55, R57, R59, R61, R63 vary also with respect to the radius of curvature R51 along the second outer curve 51.

Still preferably, the outer surface 5 has a constant radius of curvature along each second outer curve defined by the intersection of the outer surface 5 with any plane parallel to the second plane Y_0. All the radii of curvature along all the first outer curves are preferably different from each other.

For example, the radius of curvature R53 is greater than the radius of curvature R55, that is in turn greater than the radius of curvature R57, that is in turn greater than the radius of curvature R51.

Furthermore, the radius of curvature R51 is greater than the radius of curvature R59 and so on.

In other words, the radius of curvature between different second outer curves has a trend that decreases passing from one side to the other of the lens 1. Or vice versa, the radius of curvature between different second outer curves has a trend that increases passing from one side to the other of the lens 1.

In the case of sun lenses, the present invention allows to provide a lens in which the optical aberration is reduced.

In FIG. 9 an exemplary image of the difference between an ideal case of a lens devoid of optical aberrations, represented by a reference grid G1, and a lens 1 according to the invention, represented by a grid G2 associated to such lens 1, is depicted. As can be observed, because of the optimization of the shape of the surfaces, aimed at reducing the optical aberrations, the variation between the grid G2 associated to the lens 1 according to the present invention and the reference grid G1 is minimal. In other words, the lens 1 according to the present invention comes close to the ideal case.

The suitable design of the lens 1, with the radii of curvature R30, R31 on the inner surface 8, allows to optimize the optical properties of spherical power, astigmatic power, and prismatic power of the lens 1 itself.

A process for designing and/or making a lens 1 as described above forms also part of the present invention.

The process according to the present invention applies to the designing and/or making of both sun lenses and corrective or ophthalmic lenses.

Such process involves identifying a target configuration of a lens 1 with determined desired aesthetic features, wherein the outer surface 5 of the lens 1 itself is concave toward the outside (convex toward the wearer) along at least one vertical direction.

In particular, the process comprises a first step (a) of selecting for the outer surface 5 a desired outer radius of curvature R50 that is positive (with respect to a center positioned on the side of the wearer's eye) and constant along at least the first outer central curve 50.

Such first step (a) further comprises selecting, still for the outer surface 5, a desired outer radius of curvature R51 that is negative (with respect to a center positioned on the side of the wearer's eye) and constant along at least the second outer central curve 51.

In other words, the first step (a) relates to the selection of constant radii of curvature R50, R51 of the outer surface 5, that are respectively positive along the first outer central curve 50, so as to confer an outer concavity along the vertical direction to the lens 1, and negative along the second outer central curve 51, so as to confer an outer convexity along the horizontal direction to the lens 1.

The first step (a) is the same for designing and/or making both sun and corrective or ophthalmic lenses.

In the case of designing and/or making sun lens, the process comprises a subsequent step (b) of computing, for the inner surface 3, an inner radius of curvature R30 that varies along the first inner central curve 30 and an inner radius of curvature R31 that varies along the second inner central curve 31, where such inner radii R30, R31 are computed so as to minimize the optical aberrations of a semifinished lens 10 having the above-mentioned outer surface 5 and inner surface 3.

In the case of designing and/or making corrective or ophthalmic lens, the process comprises a step (b), subsequent to the step (a), of computing, for the inner surface 3, an inner radius of curvature R30 that varies along the first inner central curve 30 and an inner radius of curvature R31 that varies along the second inner central curve 31, where such inner radii R30, R31 are computed so as to confer a desired optical power or gradation to a semifinished lens 10 having the above-mentioned outer surface 5 and inner surface 3.

Thus, the process comprises a further step (c), subsequent to the step (b) of computing the inner radii of curvature R31 and R31. The step (c) involves fabricating, on the basis of such desired outer radii of curvature R50, R51 and such computed inner radii of curvature R30, R31, a semifinished lens 10 having an inner surface 3 characterized by the above-mentioned inner radii of curvature R30, R31 along the first inner central curve 30 and along the second inner central curve 31 as computed to minimize the aberrations or to confer a desired optical power or gradation, and an outer surface 5 characterized by the above-mentioned outer radii of curvature R50, R51 along the first outer central curve 50 and along the second outer central curve 51 as initially selected.

In particular, such step of fabricating a semifinished lens 10 preferably involves injection-molding the semifinished lens 10.

Once fabricated the semifinished lens 10, the process comprises a subsequent step (d) of shaping the semifinished lens 10 to achieve a lens 1 according to the invention, i.e., a lens 1 having an inner radius of curvature R30 that varies continuously and in an increasing and/or decreasing manner at least along the first inner central curve 30, and an inner radius of curvature R31 that varies continuously and in an increasing and/or decreasing manner at least along the second inner central curve 31.

The steps (c) and (d) apply to the designing and/or making of both sun and corrective or ophthalmic lenses. Preferably the step (a) comprises the step of selecting a plurality of desired outer radii of curvature along a plurality of respective outer curves. In other words, the step (a) comprises the step of selecting constant outer radii of curvature at the intersection of the outer surface 5 with a plurality of second planes Y_0, Y_10, Y_20, Y_30, Y_-10, Y_-20, Y_-30 and first planes X_0, X_2, X_4, X_6, X_-2, X_-4, X_-6.

In the same manner, the step (b) comprises the step of computing, for the inner surface 3, a plurality of inner radii of curvature that vary along a plurality of respective inner curves respectively corresponding to the above-mentioned outer curves. In other words, the step (b) comprises the step of computing inner radii of curvature that vary (continuously and in an increasing and/or decreasing manner) at the intersection of the inner surface 3 with the same second planes Y_0, Y_10, Y_20, Y_30, Y_-10, Y_-20, Y_-30 and first planes X_0, X_2, X_4, X_6, X_-2, X_-4, X_-6 used to define outer radii of curvature of the outer surface 5 of the lens 1.

Preferably, in the case of designing and/or making sun lenses, the step (b) of computing the varying inner radii of curvature to minimize the optical aberrations comprises the step of computing the varying inner radii of curvature that optimize at least one of spherical power, astigmatic power, and prismatic power of the lens 1.

Still more preferably, such step (b) comprises the step of computing the varying inner radii of curvature that optimize a weighted combination of spherical power, astigmatic power, and prismatic power of the lens 1. In other words, since generally the optimal of one of the above-mentioned three powers does not correspond to the optimal of the other two, the step (b) comprises the step of weighing the contributions given by computing each of the three powers upon minimizing the optical aberrations in order to detect the varying inner radii of curvature that ensure the best overall compromise.

The lens thus conceived, as well as the eyewear comprising such a lens, and the process for designing and/or making such a lens, is susceptible to a number of modifications and variations, all falling within the scope of the inventive concept; furthermore, all the details are replaceable by technically equivalent elements.

In practice, the used materials, as long as compatible with the specific use, as well as the contingent sizes and shapes, can be any, depending on the technical requirements.

1. A lens for spectacles and/or masks, comprising:
an inner surface configured to be directed toward at least an eye of a wearer; and
an outer surface opposite to the inner surface, said inner surface and outer surface being spaced from each other defining a thickness,
wherein
on said inner surface of said lens there is defined a first inner central curve and a second inner central curve,
on said outer surface of said lens there is defined a first outer central curve and a second outer central curve,
said first inner central curve and said first outer central curve being are defined by an intersection of said inner surface and said outer surface, respectively, with a first plane (X_0) passing through a geometric center of the lens and extending in a substantially vertical direction,
said second inner central curve and said second outer central curve are defined by the intersection of the inner surface and outer surface respectively with a second plane (Y_0) passing through the geometric center of the lens; said second plane (Y_0) being tilted with respect to a horizontal direction by an angle between −25°and 25°,
said inner surface is convex at least along said first inner central curve and concave at least along said second inner central curve toward the wearer's eye, and
said outer surface is convex at least along said first outer central curve and concave at least along said second outer central curve toward the wearer's eye.

2. The lens according to claim 1, wherein:
said inner surface has, at least along said first inner central curve, a radius of curvature (R30) that varies continuously and in an increasing and/or decreasing manner; and
said inner surface has, at least along said second inner central curve, a radius of curvature that varies continuously and in an increasing and/or decreasing manner.

3. The lens according to claim 2, wherein said radius of curvature of said inner surface along said first inner central curve is at least partly increasing and at least partly decreasing, said radius of curvature of said inner surface along said second inner central curve being at least partly increasing and at least partly decreasing.

4. The lens according to claim 2, wherein said outer surface has, at least along said first outer curve, a constant radius of curvature.

5. The lens according to claim 2, wherein said outer surface has, at least along said second outer central curve, a constant radius of curvature.

6. The lens according to claim 2, wherein said a thickness varies continuously.

7. The lens according to claim 2, wherein said inner surface has, along further first inner curves defined by the intersection of the inner surface with first planes (X_2, X_4, X_6, X_-2, X_-4, X_-6) angularly spaced with respect to said first plane (X_0), further radii of curvature, each varying continuously and in an increasing and/or decreasing manner along the respective further first inner curve.

8. The lens according to claim 7, wherein said inner surface has a radius of curvature that varies continuously and in an increasing and/or decreasing manner along any first inner curve defined by the intersection of said inner surface with any plane angularly spaced from said first plane (X_0).

9. The lens according to claim 2, wherein said inner surface has, along further second inner curves defined by the intersection of the inner surface with second planes (Y_10, Y_20, Y_30, Y_-10, Y_-20, Y_-30) parallel to the second plane (Y_0), further radii of curvature, each varying continuously and in an increasing and/or decreasing manner along the respective further second inner curve.

10. The lens according to claim 9, wherein said inner surface has a radius of curvature that varies continuously and in an increasing and/or decreasing manner along any second inner curve defined by the intersection of said inner surface with any plane parallel to said second plane (Y_0).

11. The lens according to claim 1, wherein the outer surface is cylindrical.

12. The lens according to claim 1, wherein said second plane (Y_0) extends in a substantially horizontal direction.

13. The lens according to claim 1, wherein said first plane (X_0) is tilted with respect to a vertical plane by a second angle between −30°and +30°.

14. Eyewear comprising:
at least one lens for spectacles and/or masks, said lens having an inner surface configured to be directed toward at least an eye of a wearer and an outer surface opposite to the inner surface, said inner surface and outer surface being spaced from each other defining a thickness,
wherein
on said inner surface of said lens there is defined a first inner central curve and a second inner central curve
on said outer surface of said lens there is defined a first outer central curve and a second outer central curve
said first inner central curve and said first outer central curve are defined by an intersection of said inner surface and said outer surface, respectively, with a first plane (X_0) passing through a geometric center of the lens and extending in a substantially vertical direction;
said second inner central curve and said second outer central curve are defined by the intersection of the inner surface and outer surface respectively with a second plane (Y_0) passing through the geometric center of the lens, said second plane (Y_0) is tilted with respect to a horizontal direction by an angle between −25°and 25°;
said inner surface is convex at least along said first inner central curve and concave at least along said second inner central curve toward the wearer's eye, and
said outer surface is convex at least along said first outer central curve and concave at least along said second outer central curve toward the wearer's eye.

15. Eyewear comprising:
at least one lens for spectacles and/or masks, said lens having an inner surface configured to be directed toward at least an eye of a wearer and an outer surface opposite to the inner surface, said inner surface and outer surface being spaced from each other defining a thickness,
wherein
on said inner surface of said lens there is defined a first inner central curve and a second inner central curve
on said outer surface of said lens there is defined a first outer central curve and a second outer central curve,
said first inner central curve and said first outer central curve are defined by an intersection of said inner surface and said outer surface, respectively, with a first plane (X_0) passing through a geometric center of the lens and extending in a substantially vertical direction,
said second inner central curve and said second outer central curve are defined by the intersection of the inner surface and outer surface respectively with a second plane (Y_0) passing through the geometric center of the lens,
said second plane (Y_0) being tilted with respect to a horizontal direction by an angle between −25°and 25°,
said inner surface is convex at least along said first inner central curve and concave at least along said second inner central curve toward the wearer's eye,
said outer surface is convex at least along said first outer central curve and concave at least along said second outer central curve toward the wearer's eye,
said inner surface has, at least along said first inner central curve , a radius of curvature (R30) that varies continuously and in an increasing and/or decreasing manner, and
said inner surface has, at least along said second inner central curve, a radius of curvature (R31) that varies continuously and in an increasing and/or decreasing manner.
